(19) United States
(12) Patent Application Publication
(10) Pub. No.: US 2016/0197574 A1
(43) Pub. Date: Jul. 7, 2016

(54) SYSTEMS AND METHODS FOR THERMOPHOTOVOLTAICS WITH STORAGE

(71) Applicant: GEORGIA TECH RESEARCH CORPORATION, Atlanta, GA (US)

(72) Inventor: Asegun Henry, Atlanta, GA (US)

(21) Appl. No.: 14/912,219

(22) PCT Filed: Aug. 14, 2014
(86) PCT No.: PCT/US14/51064

§ 371 Date: Feb. 16, 2016

Related U.S. Application Data
(60) Provisional application No. 61/866,609, filed on Aug. 16, 2013.

(51) Int. Cl. H02S 10/30; H02S 40/38; H02S 40/22; H02S 40/44

(52) U.S. Cl. CPC H02S 10/30; H02S 40/44; H02S 40/38; H02S 40/22

(57) ABSTRACT

Systems and methods for thermophotovoltaics with storage are disclosed. In one embodiment, includes a heat generating device configured to generate heat for a heat transfer fluid and a thermal storage device configured to receive the heat transfer fluid from the heat generating device via fluid delivery devices and cause, by the heat of the heat transfer fluid, a thermal storage material to store at least a portion of the heat of the heat transfer fluid. The system can also include a power block having a thermal emitter and a thermophotovoltaic device. The power block can be configured to receive the heat transfer fluid via the fluid delivery devices and cause, by the heat of the heat transfer fluid, the thermal emitter to emit a plurality of photons to a photovoltaic element of the thermophotovoltaic device.

### CROSS REFERENCE TO RELATED APPLICATIONS

This application claims priority to U.S. Provisional Patent Application No. 61/866,609, filed Aug. 16, 2013 and entitled “Thermophotovoltaics with Storage,” the contents of which are fully incorporated herein by reference.

### BACKGROUND

1. Technical Field

The present invention relates generally to thermophotovoltaics (TPV) and specifically to TPV with storage.

2. Background of Related Art

In concentrated solar power (CSP) systems, electric power can be produced when concentrated sunlight is converted to heat to drive a thermochemical reaction or a steam turbine connected to an electrical power generator. Conventional CSP systems may use molten salt storage and collectors such as heliostats to concentrate sunlight onto a collector tower. Molten salt storage may be slightly less expensive and have a longer life cycle compared to photovoltaics (PV) used with electrochemical batteries. These systems, however, can be very expensive (e.g., 17-27 cents/kWh levelized cost of electricity) and capital intensive, as system sizes greater than 100 MW may be required for CSP to be cost effective, since turbine cost-to-power ratio and thermal storage losses may decrease with increasing size. Flat plate photovoltaics (PV) without storage, on the other hand, has reached parity with fossil fuel generation in certain parts of the world and can be cost effective at scales below 10 MW.

In thermophotovoltaics (TPV), optical energy is not directly generated by the Sun as in traditional PV, but by materials that emit photons when heated to high temperature. The full solar spectrum can be absorbed as high temperature heat first, then a narrow portion of the infrared radiation spectrum is converted at high efficiency. The potential gain in efficiency over direct sunlight to PV comes from the fact that light reflections from a PV cell are normally lost to the atmosphere, while in TPV the low energy portion of the emitter spectrum is deliberately reflected back to the emitter and preserved as heat.

Several obstacles have prevented conventional TPV systems from reaching widespread commercial success. Among these are (1) high cost for high performance III-IV semiconductor substrates and cells; (2) low system efficiencies due to small system sizes and edge effects, and inefficient spectral control; (3) the absence of storage, which forces TPV to compete directly with less expensive flat plate PV; and (4) a large mismatch in power density between the highly concentrated sunlight input needed to reach high temperatures (>1000° C.) and the order of magnitude lower power density infrared light output from the emitter to the TPV cell. As a result there is a need for improved systems and methods to address the above mentioned deficiencies. It is with respect to these and other considerations that embodiments of the present invention are directed.

### SUMMARY

Systems and methods according to embodiments of the present invention address the above-mentioned deficiencies of conventional approaches, by combining TPV with storage to provide for, among other benefits and advantages, maximizing exergetic efficiency and lowering the cost of dispatchable energy in comparison to conventional approaches. Some embodiments of the present invention provide systems and methods that utilize TPV instead of a turbine as a power block and phase change thermal energy storage. In some embodiments of the present invention, CSP is hybridized with PV, which can provide for significantly lower cost and higher efficiency than the most efficient current combined cycle turbines, which may have approximately 60% efficiency.

According to one aspect, the present invention relates to a system that, in one embodiment, includes a heat generating device configured to generate heat for a heat transfer fluid. The system can also include a thermal storage device configured to receive the heat transfer fluid from the heat generating device via fluid delivery devices and cause, by the heat of the heat transfer fluid, a thermal storage material to store at least a portion of the heat of the heat transfer fluid. The system can also include a power block having a thermal emitter and a thermophotovoltaic (TPV) device. The power block can be configured to receive the heat transfer fluid via the fluid delivery devices and cause, by the heat of the heat transfer fluid, the thermal emitter to emit a plurality of photons to a photovoltaic element of the TPV device. The photovoltaic element can be configured to convert a first portion of the emitted photons into electric power.

According to another aspect, the present invention relates to a system that, in one embodiment, includes a solar receiver configured to receive solar radiation and direct the received solar radiation to generate heat for a liquid metal heat transfer fluid (LMHTF). The system can also include a thermal storage device configured to receive the LMHTF from the solar receiver via fluid delivery devices and produce a phase change in a thermal storage material to store at least a portion of heat contained in the LMHTF. The system can also include a power block having thermal emitters and TPV devices. The power block can be configured to receive the LMHTF via the fluid delivery devices and cause the plurality of thermal emitters to emit a plurality of photons to photovoltaic elements. The photovoltaic elements can be configured to convert a first portion of the emitted photons into electric power. According to yet another aspect, the present invention relates to a method that, in one embodiment, includes generating, by a heat generating device, heat for a heat transfer fluid. The method can also include receiving the heat transfer fluid at a thermal storage device and causing, by the heat of the heat transfer fluid, a thermal storage material of the thermal storage device to store at least a portion of the heat of the heat transfer fluid. The method can also include receiving, at a TPV device, the heat transfer fluid and causing, by the heat of the heat transfer fluid, a thermal emitter of the TPV device to emit a plurality of photons for converting at least a first portion of the emitted photons into electric power.

The foregoing and other objects, features, aspects, and advantages of the present invention will become more apparent from the following detailed description of the present invention when taken in conjunction with the accompanying drawings.

### BRIEF DESCRIPTION OF THE DRAWINGS

Reference will now be made to the accompanying drawings, which are not necessarily drawn to scale, and wherein:

FIG. 1 is a diagram illustrating a (TPV) system with storage, in accordance with one embodiment of the present invention;

FIG. 2 illustrates a cavity receiver and secondary concentrator;

FIG. 3 illustrates a fluid delivery device;

FIG. 4 illustrates a power block; and

FIG. 5 illustrates a TPV device.

### DETAILED DESCRIPTION

The following detailed description is directed to systems and methods using thermophotovoltaics with storage. Although exemplary embodiments of the present invention are explained in herein detail, it is to be understood that other embodiments are contemplated. Accordingly, it is not intended that the present invention is limited in its scope to the details of construction and arrangement of components set forth in the following description or illustrated in the drawings. The present invention is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology will be resorted to for the sake of clarity. It is intended that each term contemplates its broadest meaning as understood by those skilled in the art and includes all technical equivalents that operate in a similar manner to accomplish a similar purpose.

Ranges may be expressed herein as from “about” or “approximately” one particular value and/or to “about” or “approximately” another particular value. When such a range is expressed, another embodiment includes from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Method steps may be performed in a different order than those described herein. Similarly, it is also to be understood that the mention of one or more components in a device or system does not preclude the presence of additional components or intervening components between those components expressly identified.

In the detailed description, references are made to the accompanying drawings that form a part hereof and that show, by way of illustration, specific embodiments or examples. In referring to the drawings, like numerals represent like elements throughout the several figures.

In some embodiments of the present invention, a molten metal heat transfer fluid (also referred to herein as a liquid metal heat transfer fluid, or LMHTF) is used to distribute heat through a TPV system. Solar radiation, electric heating (e.g., electric induction, joule heating), or exothermic chemical reactions (e.g., burning fossil fuels) can produce heat to melt, among other possible materials, tin, aluminum, aluminum silicon, lead, and/or lead bismuth to form the LMHTF, and can further heat the LMHTF to a desired temperature. Fluid delivery devices such as high temperature pumps, pipes, and valves formed from ceramics or other refractory materials (refractories) can be used to control distribution of the heat through the system. A thermal storage device can receive the heat transfer fluid and, using the heat contained in the heat transfer fluid, cause a phase change in a thermal storage material encapsulated in thermal storage elements. The thermal storage device can include, for example, tubes (i.e., thermal storage elements) formed from mullite or other materials. The thermal storage elements can encapsulate silicon or an aluminum silicon alloy used as the thermal storage material. A power block can generate electric power from heat delivered by the fluid delivery devices, using TPV modules (one or more TPV cells) formed with InGaAs cells on reusable InP substrates. Thermal emitters in the power block can generate photons for generating electricity via photovoltaic (PV) cells, and reflectors can reflect photons not converted by the TPV cells back to the thermal emitters to be absorbed as heat, to keep the thermal emitter hot and thus enable further photon emission. This process of converting certain emitted photons and reflecting others back to an emitter may be referred to as photon recycling.

In some embodiments of the present invention, a solar collector receives electromagnetic radiation from the Sun and directs the received solar radiation to a solar collector. Collectors such as heliostats can be used in combination with secondary concentrators to produce high temperature heat. The receiver can be configured receive the reflected, concentrated solar radiation through one or more apertures and utilize the concentrate solar radiation to generate heat. The receiver can be configured as a cavity receiver to produce high temperature heat and radiate the heat to a LMHTF. The LMHTF can be used to deliver heat to various components in the system, via high-temperature pumps and containment elements including pipes and valves constructed from ceramics or other materials capable of thermal stability at high temperatures (e.g., 1000-1500° C. or higher). The radiation entering the receiver can be absorbed by the receiver and radiated to an outer surface of the high-temperature containment pipes. Heat absorbed by the outer surface of the containment pipes can be conducted to the heat transfer fluid inside. To prevent oxidation of the LMHTF or other components, the entire system can be held in an inert environment (e.g., N₂, Ar, vacuum). The TPV devices (TPV cells, modules, etc.) can also be held in a vacuum environment to minimize heat leakage from the emitter to TPV devices, via conduction through the gas between the emitter and TPV devices. Furthermore, a transparent window in the inert containment can be used to contain the inert environment while also allowing light to enter into the system.

In some embodiments of the present invention, the LMHTF captures the concentrated sunlight and can be used to charge and discharge a thermal energy storage device. Suitable materials for the LMHTF are those which have low melting points, high boiling points, and are inexpensive. In some embodiments of the present invention, the metals do not boil at temperatures greater than about 1000-1500° C. or higher. The metals can include one or more inexpensive scrap metals such as tin, aluminum, or lead. The cavity receiver can also be fabricated from materials that can withstand the high temperatures of the LMHTF, e.g., 1000-1500° C. or higher, and that are not corroded by the LMHTF. In embodiments of the present invention, components of the receiver can be formed from ceramics or other refractory materials.

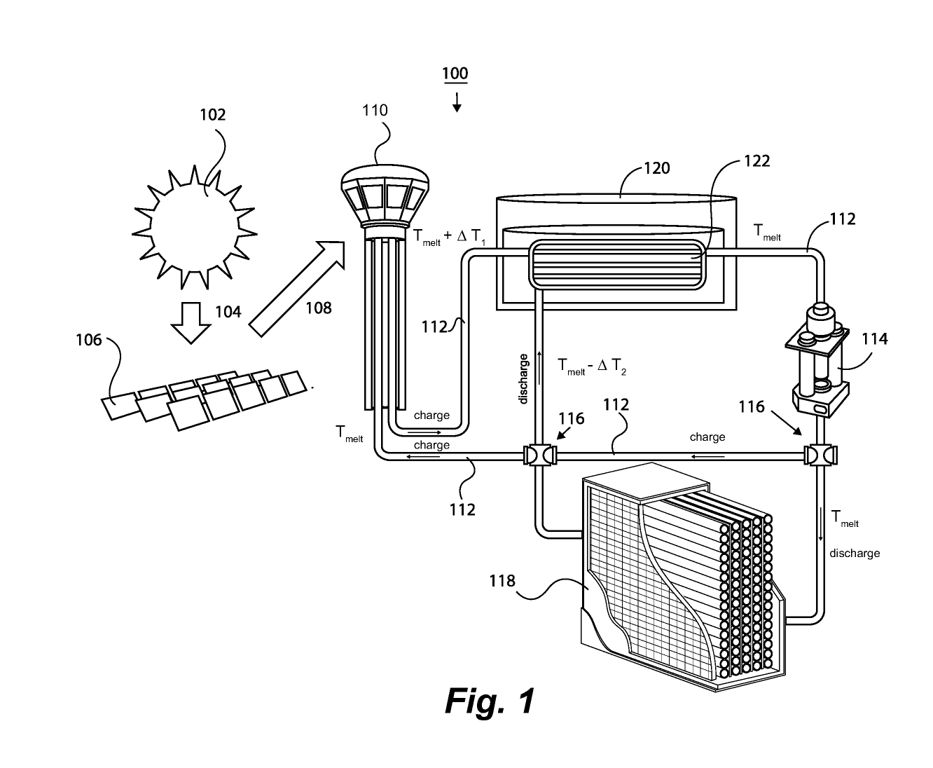

FIG. 1 is a diagram of a concentrated solar TPV system 100 with phase change thermal storage, according to one embodiment of the present invention. An array of heliostats 106 perform first level light collection to concentrate radiation 104 received directly from the Sun 102. The heliostats 106 can be small mesoscale (≦1 m²) heliostats, which can achieve higher first level concentration than existing large (e.g., >10 m²) aperture heliostats, and at approximately one third of the cost. The solar radiation is directed from the heliostats 106 (see reflected solar radiation 108) to a collector tower 110 where it can be further concentrated by a secondary concentrator in order to reach fluxes that may be greater than 5 MW/m².

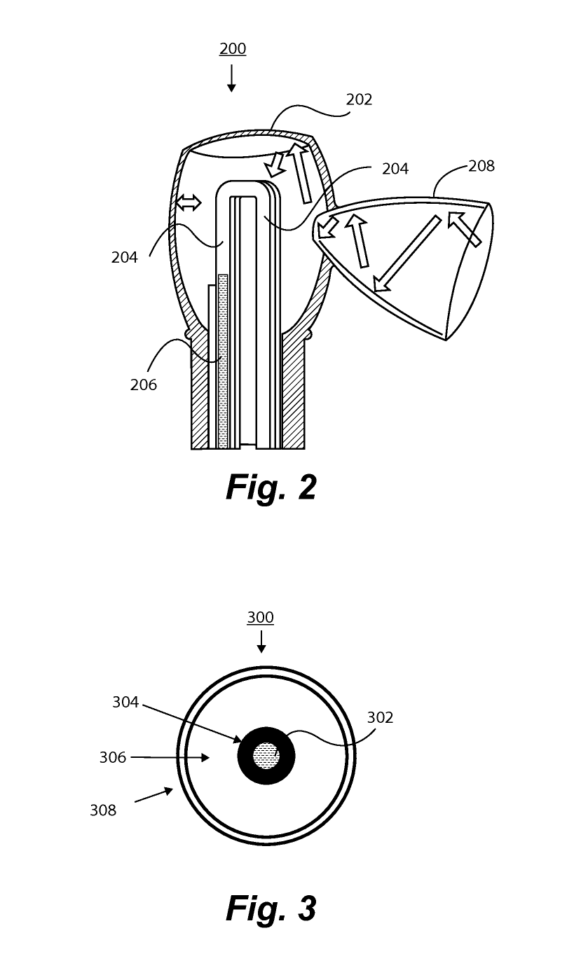

A high temperature pump 114 such as a gear pump, centrifugal pump, sump pump, or other type of mechanical or electromagnetic pump, circulates the LMHTF (see e.g., LMHTF 206 in FIG. 2 and LMHTF 302 in FIG. 3) between the collector tower 110, a thermal storage device 120, and a TPV power block 118 via the pump 114, pipes 112, and flow diverters (e.g., valves) 116 (collectively “fluid delivery devices”). The fluid delivery devices 112, 114, 116 can be constructed of high thermal conductivity, high strength ceramics and ceramic material composites or other refractory materials to contain the LMHTF and transfer the heat efficiently. The LMHTF can be molten metal formed with tin, lead, or lead bismuth, for example, or other materials.

Although not specifically shown in FIG. 1, the LMHTF can be stored at and/or formed at a reservoir and then selectively injected into system 100 via pumps and control valves. For example, the LMHTF may be melted by solar radiation, thermochemical reactions, and/or electric induction heating or joule heating to form the LMHTF. In some embodiments of the present invention, CSP is not required to generate the heat for (i.e., to be delivered to or contained in) the LMHTF. Other techniques may be used, provided the LMHTF effectively holds generated heat for delivery to components in the system 100. For example, the LMHTF may hold heat produced by electric heating or chemical reactions. In some embodiments, the present invention is not limited to requiring a solar collection and sunlight-to-thermal energy conversion system, and can be used more broadly. For example, electricity can be used (via joule heating, for instance) to add heat to the thermal storage medium, either directly or through the LMHTF, which can be electrically conductive. In some embodiments, the thermal storage device can later be discharged into a power cycle to recover a large fraction of the input energy back as electricity. As referred to herein, a power cycle may encompass turbomachinery (machines such as turbines and compressors for transferring energy between a rotor and a fluid), solid state heat engines, or a combination thereof to form what can be considered a combined cycle. The power cycle in some embodiments can be a TPV-based power cycle.

Heat transferred via the LHMTF is used to melt a phase change alloy in the thermal storage device 120. The thermal storage device 120 can use mullite tubes 122 (i.e., thermal storage elements) for encapsulating the phase change material, which in some embodiments can be an aluminum silicon alloy (e.g., AlₓSi₁₋ₓ, where 0≦x≦0.3 depending on the target melting temperature). The thermal storage elements can alternatively or additionally be formed from materials other than mullite, for example other materials that are chemically compatible with aluminum and/or silicon. The transferred heat can be stored in and released from the aluminum silicon alloy by the latent heat of fusion, which can be approximately 1.92 MJ/kg. The aluminum silicon alloy in the sealed mullite tubes 122 can thereby serve as an encapsulated phase change material (i.e., storage medium), which may have an associated storage cost of approximately $7.5/kWh-th including the cost of the mullite.

To charge the thermal storage device 120 (see “charge” directional arrows), the LMHTF can be pumped to the top of the collector tower 110 and heated from the melting point Tₘₑₗₜ of the aluminum silicon alloy to ≈Tₘₑₗₜ+ΔT₁, via sensible heating. A high flow rate and small temperature rise ΔT≈50° C. can be utilized to maximize the system level exergetic efficiency. The LMHTF at Tₘₑₗₜ+ΔT₁ can then be routed to the thermal storage device 120, where it can surround/flow around the mullite tubes 122 and melt the encapsulated phase change material, and then can be cooled to Tₘₑₗₜ, and then recirculated back to the collector tower 110. Heat stored at the thermal storage device 120 can be discharged (see “discharge” directional arrows”), whereby the LMHTF is circulated from the thermal storage device 120 to a power block 118. Thus, the LMHTF can be used as a transport fluid for capturing the concentrated sunlight and charging and discharging the thermal storage device 120.

FIG. 2 is a partial view of a secondary concentrator 208 and cavity receiver 202 (collectively 200) that can be used in a solar collector in accordance with some embodiments of the present invention, for example in the collector tower 110 shown in FIG. 1. The secondary concentrator 208 can be formed with one or more compound parabolic concentrators (CPC) (e.g., hollow or solid) and can be configured for direct or total internal reflection or other means of imaging or non-imaging optical concentration. In some embodiments of the present invention, an array of multiple secondary concentrators (not shown) can be used. As shown in FIG. 2, solar radiation that is further concentrated by the secondary concentrator 208 enters the cavity receiver 202, which may be held in a vacuum. At the cavity receiver 202, the concentrated solar radiation is used to heat a liquid metal heat transfer fluid (LMHTF) 206. Tin, lead, and/or lead bismuth, among other metals, can be used for the LMHTF 206.

FIG. 3 is a cross-sectional view of a fluid delivery device 300 that can be used for containing LMHTF 302 and insulating the associated heat in some embodiments of the present invention. The pipes 112 in the embodiment of the present invention shown in FIG. 1 can include one or more components of the fluid delivery device 300. The fluid delivery device 300 includes a ceramic or other refractory containment portion 304 for directly containing the LMHTF 302, a thermal containment portion 306 surrounding the ceramic containment portion to minimize heat leakage to a colder surrounding environment, and an inert atmosphere containment portion 308 surrounding the thermal containment portion 306, which can prevent the penetration of oxygen into the system from the externally surrounding atmosphere.

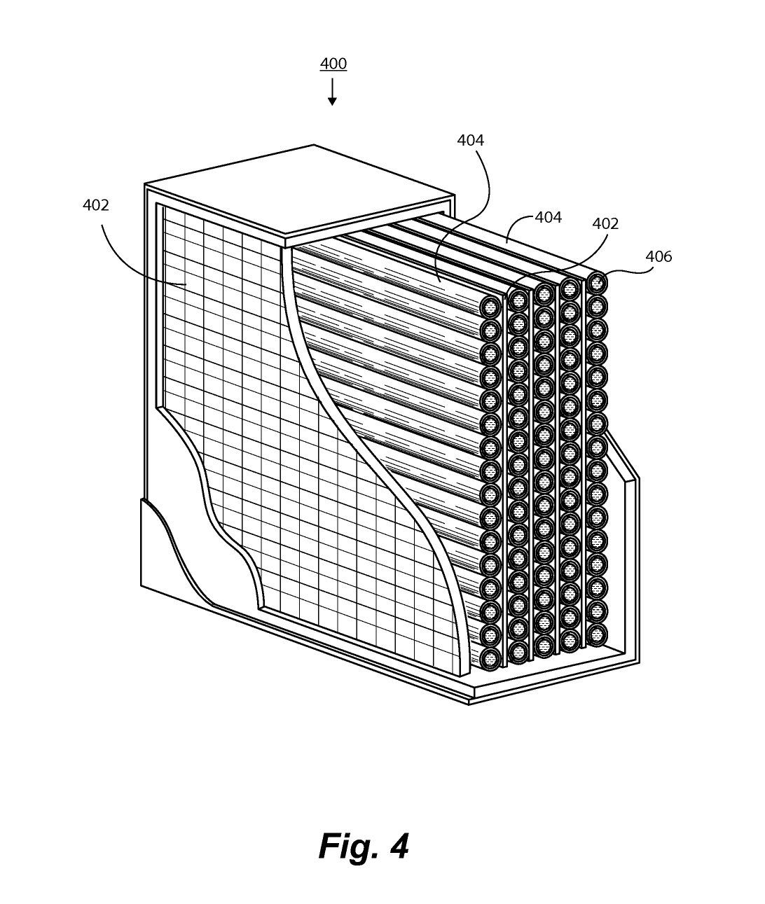

FIG. 4 provides a cutaway view of a power block 400 that can be used in some embodiments of the present invention. The power block 400 can be configured to generate electric power using heat transferred by a LMHTF 406 in accordance with one or more embodiments of the present invention. For example, the power block 400 may correspond to the power block 118 shown in FIG. 1. The power block 400 includes an array of thermal emitters 404 through which the LMHTF 406 flows and uses heat contained in the LMHTF 406 to cause the emission of photons. The thermal emitters 404 may be tubes formed with ceramics or other refractory materials and configured as near blackbody emitters or spectrally selective emitters. The thermal emitters 404 may alternatively take various other shapes and can be formed from a variety of or combination of materials, provided the materials allow for efficient generation of photons when heated. The thermal emitters 404 may be formed with graphite, silicon nitride (Si₃N₄), silicon carbide (SiC), and/or aluminum nitride (AlN) or various other refractory materials, for example. The thermal emitters 404 may be configured as selective emitters through the use of wavelength-specific filters or specific coatings to allow desired portions of the spectrum to be emitted rather than others. For example, tubes can be coated with particular compositions configured to create emissions in a narrow wavelength range of the spectrum (e.g., high energy photons in the infrared portion of the spectrum) that is optimized for the TPV devices 402 used for producing electricity.

The entire power block 400 can be heavily insulated from the environment and held in a vacuum to minimize heat losses. The dimensions of the power block 400 should be sufficiently large (e.g., volume-to-surface area ratio on the order of 1 m) to minimize edge effects. Dispatchability is enabled through the rate of discharge, which can be controlled by the flow rate of the LMHTF 406 through the thermal emitters 404 and also the radiative view factor between the TPV devices 402 and thermal emitters 404. The TPV devices 402, which can remain near room temperature via active cooling, can be physically moved or displaced by an actuator or mechanical device or otherwise change the view factor between the TPV devices 402 and thermal emitters 404. This can lead to unprecedented response times, as implementations of the present invention in one or more embodiments can change from minimum to maximum output on the order of seconds or less as governed by the speed of the actuated control system.

The TPV devices 402 can be disposed in between successive columns of the thermal emitters 404 and irradiated with blackbody emission between Tₘₑₗₜ and Tₘₑₗₜ−ΔT₂, wherein a small ΔT₂ is used to preserve high exergetic efficiency, and the heat is transferred to the emitters via sensible cooling in the LMHTF 406. At volume-to-surface area ratios of ˜1 m (e.g., scales ≈10 MWe), heat losses/edge effects from the thermal emitters 404 can be suppressed, since the surface area to volume ratio can be greatly reduced as compared to previous work at smaller scales, due to the power output of the power block scaling with the volume and heat losses scaling with the surface area.

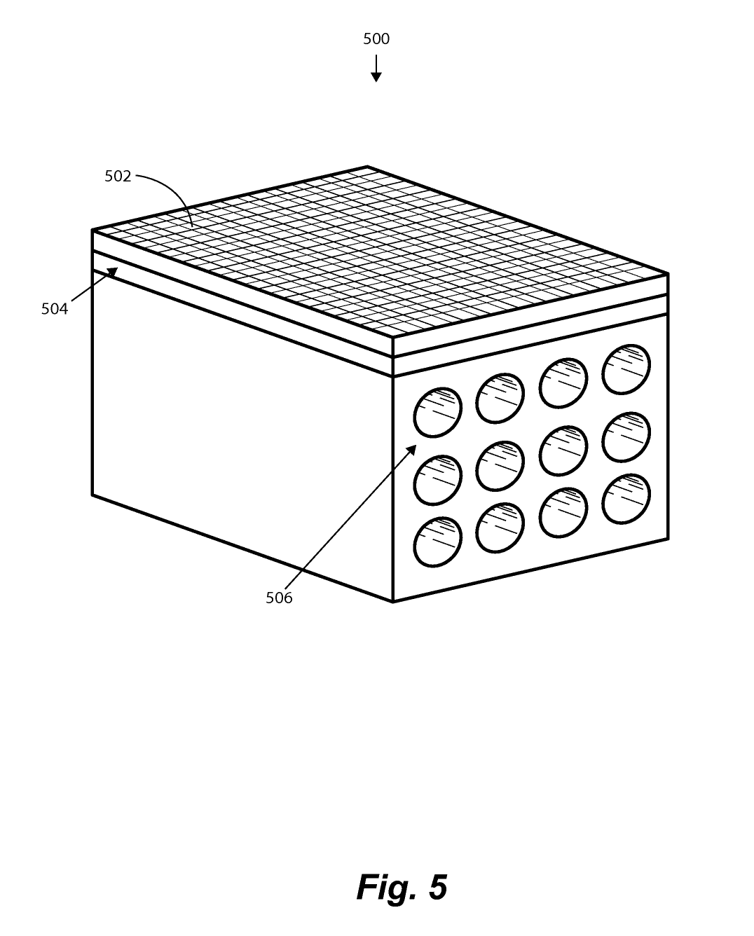

FIG. 5 shows a TPV module 500 that can be used in some embodiments of the present invention. The TPV module 500 can correspond to one or more of the TPV devices 402 shown in FIG. 4. The TPV module 500 includes high efficiency InGaAs TPV cells 502 grown on reusable InP substrates, and is backed with a silver layer 504 to serve as an inexpensive omnidirectional high efficiency reflector. The silver layer 504 and the rest of the TPV module 500 can be configured to minimize below band gap absorption and efficiently convert the upper 15-20% of the spectrum, which may be peaked between 1.72-1.97 micron (1200-1414° C.). The TPV cell 500 is actively cooled behind the substrate with a water/oil cooled heat sink 506 and is kept near ambient temperature to maximize performance.

Among other benefits, by the use of mesoscale heliostats, AlₓSi₁₋ₓ phase change thermal storage and high performance InGaAs TPV cells grown on reusable InP substrates according to some embodiments of the present invention, the levelized cost of electricity of CSP can be reduced by up to a factor of three, as compared to the current approaches. By using a LMHTF in accordance with some embodiments of the present invention, the power density of the receiver can be decoupled from that of the power block in order to solve the power density mismatch and allow the use of thermal storage, thereby enabling an entirely new way of utilizing TPV. Furthermore, by operating TPV at the utility scale and using silver back reflectors for spectral control, in accordance with some embodiments of the present invention, full benefits of photon recycling can be realized.

Numerous characteristics and advantages have been set forth in the foregoing description, together with details of structure and function. While various embodiments of the processing systems and methods have been disclosed in exemplary forms, many modifications, additions, and deletions can be made without departing from the spirit and scope of the present invention and its equivalents as set forth in the following claims. Therefore, other modifications or embodiments as may be suggested by the teachings herein are particularly reserved as they fall within the breadth and scope of the claims here appended.

What is claimed is:

1. A system, comprising:
a heat generating device configured to generate heat for a heat transfer fluid;
a thermal storage device configured to receive the heat transfer fluid from the heat generating device via fluid delivery devices and cause, by the heat of the heat transfer fluid, a thermal storage material to store at least a portion of the heat of the heat transfer fluid; and
a power block comprising a thermal emitter and a thermophotovoltaic (TPV) device, the power block being configured to receive the heat transfer fluid via the fluid delivery devices and cause, by the heat of the heat transfer fluid, the thermal emitter to emit a plurality of photons to a photovoltaic element of the TPV device, the photovoltaic element being configured to convert a first portion of the emitted photons into electric power.

2. The system of claim 1, wherein the heat generating device is configured to generate the heat for the heat transfer fluid by at least one of electric heating, an exothermic chemical reaction, and concentrated solar radiation.

3. The system of claim 1, wherein the power block further comprises a reflector configured to reflect a second portion of the emitted photons back to the thermal emitter.

4. The system of claim 1, wherein the thermal storage device is further configured to discharge at least a portion of the stored heat back into the heat transfer fluid.

5. The system of claim 1, wherein the heat transfer fluid is formed at least partially from an electrically conductive material.

6. The system of claim 5, wherein the heat generating device is configured to generate at least a portion of the heat for the heat transfer fluid by electric induction or joule heating.

7. The system of claim 5, wherein the thermal storage device is configured to store, by the electrically conductive material of the heat transfer fluid, energy in the system.

8. The system of claim 1, further comprising a power cycle configured to convert energy in the system between thermal energy and electrical energy.

9. The system of claim 1, wherein the heat transfer fluid is a liquid metal heat transfer fluid (LMHTF).

10. The system of claim 1, wherein the TPV device comprises an InGaAs cell.

11. The system of claim 10, wherein the InGaAs cell is formed on an InP substrate.

12. The system of claim 1, wherein the thermal storage material is contained by a thermal storage element formed at least partially of a refractory material.

13. The system of claim 1, wherein the thermal emitter is configured as a selective emitter.

14. The system of claim 1, wherein the fluid delivery devices comprise at least one of a pipe and valve formed from a refractory material.

15. The system of claim 1, wherein the fluid delivery devices comprise at least one of a mechanical and electromagnetic pump.

16. A system, comprising:
a solar receiver configured to receive solar radiation and direct the received solar radiation to generate heat for a liquid metal heat transfer fluid (LMHTF);
a thermal storage device configured to receive the LMHTF from the solar receiver via fluid delivery devices and produce a phase change in a thermal storage material to store at least a portion of heat contained in the LMHTF; and
a power block comprising thermal emitters and thermophotovoltaic (TPV) devices, the power block being configured to receive the LMHTF via the fluid delivery devices and cause the plurality of thermal emitters to emit a plurality of photons to photovoltaic elements, the photovoltaic elements being configured to convert a first portion of the emitted photons into electric power.

17. The system of claim 16, wherein the LMHTF is a molten metal comprising at least one of tin, aluminum, aluminum silicon, lead, and lead bismuth.

18. The system of claim 16, wherein the thermal storage material comprises at least one of silicon and an aluminum silicon alloy.

19. The system of claim 16, further comprising a plurality of collectors configured to directly receive the solar radiation and direct the solar radiation to the solar receiver.

20. The system of claim 16, wherein the power block further comprises reflectors configured to reflect a second portion of the emitted photons back to the thermal emitters.

21. The system of claim 16, wherein the thermal storage device is further configured to discharge at least a portion of the stored heat back into the LMHTF.

22. The system of claim 16, wherein at least one of the TPV devices comprises an InGaAs cell.

23. The system of claim 22, wherein the InGaAs cell is formed on a InP substrate.

24. The system of claim 16, wherein the thermal storage material is contained by thermal storage elements formed at least partially of a refractory material.

25. The system of claim 16, wherein at least one of the thermal storage elements is formed at least partially of mullite.

26. The system of claim 16, wherein the thermal emitter is formed at least partially of at least one of graphite, silicon nitride, silicon carbine, and aluminum nitride.

27. The system of claim 16, wherein the thermal emitter is configured as a selective emitter.

28. The system of claim 16, wherein the fluid delivery devices comprise at least one of a ceramic pipe and ceramic valve.

29. The system of claim 16, wherein the fluid delivery devices comprise a gear pump, centrifugal pump, or sump pump.

30. The system of claim 16, further comprising an electrical heating device configured to heat the LMHTF by electric induction or joule heating.

31. The system of claim 16, wherein the thermal storage device is configured to store, at least by electrically conductive material of the LMHTF, electrical energy in the system.

32. The system of claim 16, further comprising a power cycle configured to convert energy in the system between thermal energy and electrical energy.

33. A method, comprising:
generating, by a heat generating device, heat for a heat transfer fluid;
receiving the heat transfer fluid at a thermal storage device causing, by the heat of the heat transfer fluid, a thermal storage material of the thermal storage device to store at least a portion of the heat of the heat transfer fluid; and
receiving, at a thermophotovoltaic (TPV) device, the heat transfer fluid and causing, by the heat of the heat transfer fluid, a thermal emitter of the TPV device to emit a plurality of photons to a photons for converting at least a first portion of the emitted photons into electric power.

34. The method of claim 33, wherein generating heat for the heat transfer fluid comprises at least one of electric heating, exothermic chemical reactions, and concentrated solar radiation.

35. The method of claim 33, wherein causing the thermal storage material to store at least a portion of the heat of the heat transfer fluid comprises producing a phase change in the thermal storage material.

36. The method of claim 33, further comprising reflecting, by a reflector, a second portion of the emitted photons back to the thermal emitter.

37. The method of claim 33, further comprising discharging, from the thermal storage device, at least a portion of the stored heat back into the heat transfer fluid.

38. The method of claim 33, further comprising delivering the discharged heat to the thermal emitter.

39. The method of claim 33, further comprising storing, by an electrically conductive material of the heat transfer fluid, electrical energy.

40. The method of claim 33, further comprising converting, via power cycle, energy between thermal energy and electrical energy in a system comprising the heat generating device, heat transfer fluid, and thermal storage device.
